(19) United States
(12) Patent Application Publication
(10) Pub. No.: US 2012/0025553 A1
(43) Pub. Date: Feb. 2, 2012

(54) Fluid Technology Device, in Particular Gripping Apparatus

(75) Inventors: Markus Fischer, Ostfildern (DE); Ruwen Kaminski, Stuttgart (DE)

(73) Assignee: FESTO AG & CO. KG, Esslingen (DE)

(21) Appl. No.: 13/259,678

(22) PCT Filed: Mar. 24, 2010
(86) PCT No.: PCT/EP2010/001830

§ 371 Date: Sep. 23, 2011

(30) Foreign Application Priority Data
Mar. 26, 2009 (DE) 10 2009 015 975.4

(51) Int. Cl. F16L 21/06; B25J 15/00; F16L 21/00

(52) U.S. Cl. 294/198; 285/18

(57) ABSTRACT

A fluid technology device, in particular a gripping apparatus, is disclosed, which is provided with at least one fluidic connection assembly (13) for supplying fluid, wherein the device is made of plastic material by using a generative manufacturing method. The connection assembly (13) has an insertion recess (29) which is formed by way of the generative manufacturing method and is provided with a clamping and releasing structure (32, 33) for fixing and releasing fluid tubes which are to be inserted without any other auxiliary means.

The invention relates to a fluid technology device, in particular a gripping apparatus, having at least one connection assembly for supplying fluid, wherein the device is produced from plastic material by using a generative manufacturing method.

Fluid technology devices of this kind, which are produced by using a generative manufacturing method and designed as a gripping apparatus, are known, for example, from DE 10 2005 046 160 C5 or DE 10 2006 022 855 A1. Generative manufacturing methods are a broad term for the methods which are often also referred to as Rapid Prototyping methods for manufacturing products rapidly and cost-effectively. This manufacture takes place directly based on computer-internal data models, in particular from amorphous powders by means of chemical and/or physical processes. Although these are primary shaping methods, no special tools which have stored the respective geometry of the workpiece, such as casting moulds, are required to create a material product. Amongst various known methods, laser sintering is especially suitable for producing fluid technology devices, in particular gripping apparatuses. In the course of this, three-dimensional structures are produced from a base material in powder form by sintering. Using a generative layer manufacturing method the workpiece is constructed layer by layer. Any three-dimensional geometries, even with undercuts, can be produced by the effect of the laser beams in this way, for example even workpieces which cannot be produced in conventional mechanical or casting manufacture. Structures formed as one part or interconnected and formed from more than one part can thereby be produced at the same time using the same process. The basic prerequisite for this is that the geometrical data for the product is available three-dimensionally and can be processed as layer data, for example as CAD data.

The fluidic gripping apparatuses which are known from the previously mentioned publications have a connection opening for supplying the fluid. This is usually supplied via fluid tubes. To connect a fluid tube to such a connection opening, according to the prior art a connection screw fitting, usually consisting of metal, is required, which is screwed into the connection opening. For example, a screw fitting according to DE 200 08 129 U1 is suitable for this purpose. This is provided with a clamping structure and releasing structure for inserting the tube in a sealing and fixing manner. As an additional part, this screw connection results in increased costs and time and effort for assembly.

An alternative arrangement for connecting a fluid tube to such a connection opening is known from EP 0160550 B1. A retaining part, which is provided with a claw structure, is located in the connection opening, wherein the claw structure fixes the fluid tube in place when it is inserted. Another separate releasing part is required to release the claw structure from the fluid tube. The additional parts also here result in increased costs and increased time and effort for assembly.

An object of the present invention involves improving a fluid technology device of the type mentioned at the beginning in such a way that a connection tube for providing fluid can be connected to this device without additional auxiliary means.

This object is achieved according to the invention by a fluid technology device having the features of claim 1.

The fluid technology device according to the invention has the advantage that with the generative manufacturing method the connection assembly and the corresponding insertion recess are provided with a clamping structure and releasing structure for fixing in place and releasing fluid tubes without additional work steps. An additional screw connection can therefore be omitted, that is, the fluid tube can be directly inserted into the insertion recess provided with the clamping structure and releasing structure and produced by means of the generative manufacturing method, so that it can be immediately automatically fixed in place in a sealing manner. The clamping structure and releasing structure are therefore automatically produced at the same time as the fluid technology device is produced without additional work steps being necessary. Dispensing with the screw connection screw fitting, as a result, leads to simpler assembly and lower costs.

Advantageous enhancements and improvements to the fluid technology device specified in claim 1 can be made by means of the measures cited in the sub-claims.

Selective laser sintering as the generative manufacturing method is particularly suitable for producing fluid technology devices.

A sealing ring structure is expediently integrally formed in the insertion recess to hold a fluid tube in a sealing manner, so that an additional sealing ring can be dispensed with.

An annular claw structure, preventing an inserted fluid tube from being pulled out, integrally formed in the insertion recess is also particularly advantageous. This claw structure can also be formed particularly easily without additional effort by means of the generative manufacturing method or selective laser sintering.

In the insertion recess, the releasing structure particularly advantageously also has a tubular releasing part which is axially displaceable and lifts the claw structure to release an inserted fluid tube from it. While the rest of the fluid technology device is integrally formed by the generative manufacturing method, this releasing part is a separate part and can nevertheless be produced at the same time using the generative manufacturing process with the rest of the fluid technology device without an additional work step. Locking mechanisms, which prevent the releasing part from falling out, can thereby be easily produced as elements which grip behind.

The fluid technology device according to the invention is expediently designed as a gripping apparatus having at least two grippers, wherein a bellows apparatus which can be charged with fluid via the connection assembly is mechanically connected to the grippers to move them. The grippers are at the same time expediently attached in an articulated manner to a base structure holding the bellows apparatus and by means of the bellow apparatus, which expands when charged with fluid, they can be pivotably actuated via coupling elements. Required articulated joints and linkages can also be easily accomplished by means of the generative manufacturing method.

The connection assembly is expediently arranged on the base structure, in particular on the opposed end region with respect to the grippers.

The grippers advantageously in each case consist of two flexible ribs which are connected to one another at the free gripping end and are fixed spaced apart from one another to a pivotable gripper base which can be actuated by means of the bellows apparatus. It has proved particularly favourable if the two ribs are connected to one another by a plurality of parallel struts which are attached to the ribs in an articulated manner. An advantage arises as a result of this in that the grippers, when gripping an object, after first coming into contact automatically bend around the object and in this way fix it in place particularly well.

Polyamide has proved particularly suitable as the plastic material.

An exemplary embodiment of the invention is illustrated in the drawing and explained in more detail in the following description. In the drawing:

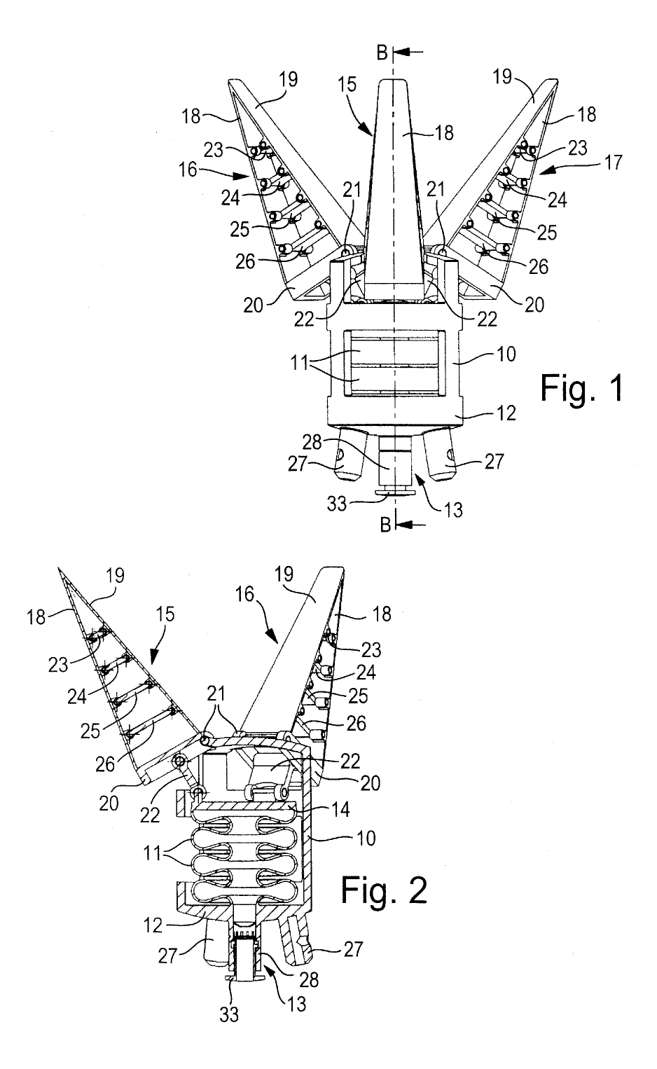

FIG. 1 shows a gripping apparatus, provided with three grippers, as a fluid technology device in a side view as the exemplary embodiment of the invention,

FIG. 2 shows a sectional representation of the gripping apparatus illustrated in FIG. 1 in accordance with the intersecting line B-B and

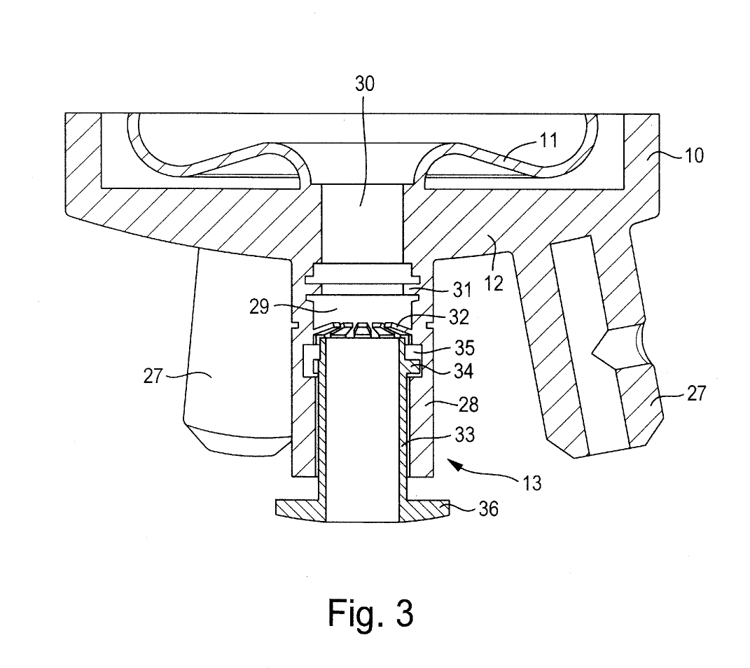

FIG. 3 shows an enlarged detailed representation of the fluidic connection assembly, provided with a clamping structure and releasing structure, and insertion recess for fluid tubes.

The fluid technology gripping apparatus, illustrated in FIGS. 1 to 3 as an exemplary embodiment of the invention, as a fluid technology device consists of a base structure 10 which resembles a housing, in which an integrally formed bellows apparatus 11 is arranged. An end region of the bellows apparatus 11 is formed onto a base plate 12 of the base structure 10 and is aligned with a fluidic connection 13 which is also integrally formed onto the base plate 12 and will be described in more detail in conjunction with FIG. 3. The opposite end region of the bellows apparatus 11 is terminated by an actuating plate 14.

Three grippers 15-17 are attached in an articulated manner to the end region of the base structure 10 remote from the base plate 12. Each of the grippers 15-17 consists of two flexible ribs 18, 19 which are connected to one another at the free gripper end and which are fixed to a gripper base 20 spaced apart from one another and forming a triangular-like arrangement. An end region of such a gripper base 20 is in each case connected to the base structure 10 via a pivot joint 21. The actuating plate 14 is in each case connected to the gripper base 20 of the three grippers 15-17 via a coupling element 22. The coupling elements 22 thereby grip in the middle region of the respective gripper base 20 and thus spaced apart from the pivot joint 21. The coupling elements 22 are connected in an articulated manner at both ends to the actuating plate 14 and the respective gripper base 20, but if the articulated connections are omitted the coupling elements 22 can themselves also be designed to be flexible.

The two ribs 18, 19 of the grippers 15-17 are additionally also connected to one another by four parallel struts 23-26 which in turn are arranged parallel to the gripper base 20. These parallel struts 23-26 are in each case connected in an articulated manner at both end regions to the ribs 18, 19. The number of parallel struts 23-26 can, of course, also vary and in the most basic case the struts can also be omitted.

Three more retaining fixtures 27 are formed onto the base plate 12, which extend from the exterior and serve to fasten the entire gripping apparatus to a retaining fixture, which is not illustrated.

When fluid flows in via the fluidic connection 13, the bellows apparatus 11 expands in the longitudinal direction and moves the actuation plate 14 away from the base plate 12. As a result of this, the grippers 15-17 are pivoted towards one another by means of the coupling elements 22 and can thereby grip an object, which is not illustrated. By using the structural design described for the grippers 15-17, when they reach an object to be gripped they place themselves around this object and as a result achieve a particularly good grip.

The number of grippers 15-17 is, of course, not limited to three but can vary. At least two grippers must be present.

As has already been described at the beginning, the entire gripping apparatus is produced from plastic powder by means of the generative manufacturing method, in which selective laser sintering has proved to be particularly suitable as the generative manufacturing method. In the prior art specified at the outset, constructing a gripping apparatus by means of such a manufacturing method is also described in detail. Polyamide is especially suitable as the plastic material or plastic powder for constructing the gripping apparatus, but other plastic materials can also be used.

FIG. 3 shows an enlarged representation of the fluidic connection 13. It essentially consists of a tube part 28 which is integrally formed onto the base plate 12 and the interior of which is designed as an insertion recess 29 for a fluid tube which is not illustrated. The insertion recess 29 is connected to the interior of the bellows apparatus 11 via a connection channel 30. An annular elevation 31 or annular lip extends radially inwards from the inner wall of the insertion recess 29 and serves as a sealing element which abuts in a sealing manner on the fluid tube to be inserted. An annular claw structure 32 is located axially next to this and is integrally formed onto the inner wall of the insertion recess 29. The claws or ribs of the annular claw structure 32 run inclined radially inwards and are bent outwards when a fluid tube is inserted, thereby impeding or preventing the fluid tube from being pulled out.

An essentially tubular releasing part 33, which is axially displaceable, is guided into the insertion recess 29, wherein a locking mechanism 34 of the releasing part 33, the locking mechanism 34 extending radially outwards and integrally formed, engages with an annular groove 35 of the insertion recess 29 and thereby prevents the releasing part 33 from falling out. The annular groove 35 has an axial extension which is dimensioned in such a way that the releasing part 33 can be axially displaced in the required way. If the releasing part 33 is pressed into the insertion recess 29 by means of a releasing annular plate 36, then the claw structure 32 is bent outwards and thereby releases an inserted fluid tube which can then be pulled out.

However, such a claw structure 32 and a releasing part bending it outwards are, for example, known as separate conventionally produced parts from EP 0160559 B1 mentioned at the beginning.

The annular elevation 31 and the claw structure 32 are integrally formed onto the tube part 28 by means of the generative manufacturing method, wherein the releasing part 33 formed as a separate part is also formed in the same operation by the generative manufacturing method. Other structural designs for a clamping structure and releasing structure, which differ from the claw structure 32 and the releasing part 33 illustrated, can, of course, also be produced by means of the generative manufacturing method.

The invention is not limited to a gripping apparatus but can also be applied to other fluid technology devices which are produced by means of a generative manufacturing method and which have at least one connection assembly with a clamping structure and releasing structure for fluid tubes. Such fluid technology devices are, for example, valves, piston-cylinder arrangements, linear drives, rotary drives and suchlike.

Other generative manufacturing methods can also be used instead of the preferred selective laser sintering, for example stereolithography, fused deposition modelling, laminated object modelling, 3-D printing or cold gas dynamic spraying.

1. A fluid technology device, in particular a gripping apparatus, having at least one fluidic connection assembly for supplying fluid, wherein the device is produced from plastic material by using a generative manufacturing method, wherein the connection assembly has an insertion recess which is formed by using the generative manufacturing method and is provided with a clamping structure and releasing structure for fixing in place and releasing fluid tubes which are to be inserted without any other auxiliary means.

2. A device according to claim 1, wherein the generative manufacturing method is designed as selective laser sintering.

3. A device according to claim 1, wherein a sealing ring structure is integrally formed in the insertion recess to hold a fluid tube in a sealing manner.

4. A device according to claim 1, wherein an annular claw structure preventing an inserted fluid tube from being pulled out is integrally formed in the insertion recess.

5. A device according to claim 4, wherein, the insertion recess, the release structure has a tubular releasing part which is axially displaceable and lifts the claw structure to release an inserted fluid tube from it.

6. A device according to claim 1, wherein the device is designed as a gripping apparatus having at least two grippers, wherein a bellows apparatus which can be charged with fluid via the connection assembly is mechanically connected to the grippers to move them.

7. A device according to claim 6, wherein the grippers are attached in an articulated manner to a base structure holding the bellows apparatus and by means of the bellows apparatus, which expands when charged with fluid, they can be pivotably actuated via coupling elements.

8. A device according to claim 6, wherein the connection assembly is arranged on the base structure on the opposed end region with respect to the grippers.

9. A device according to claim 8, wherein the connection assembly is arranged on a base plate of the base structure.

10. A device according to claim 6, wherein the grippers in each case consist of two flexible ribs which are connected to one another at the free gripping end and are fixed spaced apart from one another to a pivotable gripper base which can be actuated by means of the bellows apparatus.

11. A device according to claim 10, wherein the two ribs are connected to one another by a plurality of parallel struts which are attached to the ribs lastically or in an articulated manner.

12. A device according to claim 1 wherein, the plastic material is polyamide.
